(19) United States
(12) Patent Application Publication
(10) Pub. No.: US 2026/0042385 A1
(43) Pub. Date: Feb. 12, 2026

(54) COMFORT ASSEMBLY WITH STITCHED TUBE ARRANGEMENT

(71) Applicant: LEAR CORPORATION, Southfield, MI (US)

(72) Inventors: Milan Tüskes, Genova (IT); Krzysztof Lechniak, Zyrardów (PL)

(21) Appl. No.: 19/285,208

(22) Filed: Jul. 30, 2025

(30) Foreign Application Priority Data
Aug. 7, 2024 (DE) 102024122512.2

(51) Int. Cl. B60N 2/90; B60N 2/56

(52) U.S. Cl. CPC B60N 2/914; B60N 2/5642

(57) ABSTRACT

An assembly includes at least one bladder, at least one fluid line, and a carrier layer supporting the at least one fluid line. The at least one fluid line is attached to the base material via a stitched attachment.

### CROSS-REFERENCE TO RELATED APPLICATION

This application is a U.S. non-provisional application claiming the benefit of German Application No. 102024122512.2, filed on Aug. 7, 2024, which is incorporated herein by reference in its entirety.

### BACKGROUND

Seats may include comfort systems that include massage and lumbar assemblies, ventilation members, and thermal members, for example.

### BRIEF DESCRIPTION OF THE DRAWINGS

FIG. 1 is a perspective view of an example seat.

FIG. 2A is a top view of a carrier layer.

FIG. 2B is a top view of a carrier layer with a first bladder and fluid line attached with a stitched attachment.

FIG. 2C is similar to FIG. 2B with additional bladders and fluid lines.

FIG. 2D is similar to FIG. 2C but shows a complete carrier and bladder assembly.

FIG. 3 is a schematic illustration of a carrier sheet with other comfort layers.

FIG. 4 is a magnified view of one example of a stitched attachment.

FIG. 5 is an exploded view of a multi-cell bladder with a button.

FIG. 6A is a top view of a carrier layer with a button opening.

FIG. 6B is a bottom view of an assembled bladder from FIG. 5.

FIG. 6C is a bottom view of a carrier layer with the button of FIG. 5 installed.

FIG. 6D is a view similar to that of FIG. 6C with the button fixed in place via a button hole opening in the carrier layer.

FIG. 7 is an exploded view of a multi-cell bladder with a stitch flag.

FIG. 8A is top view of an assembled bladder from FIG. 7.

FIG. 8B shows the bladder of FIG. 8A in a pinched position.

FIG. 8C shows an example of stitching the stitch flag to the carrier layer.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

It should be understood that terms such as “about,” “substantially,” and “generally” are not intended to be boundaryless terms, and should be interpreted consistent with the way one skilled in the art would interpret those terms.

This disclosure relates to a fan assembly having a housing and a fan mounting bracket that are positioned on opposing sides of a carrier sheet, and which are attached to each other such that material of the carrier sheet forms a sealed interface between the fan mounting bracket and the housing.

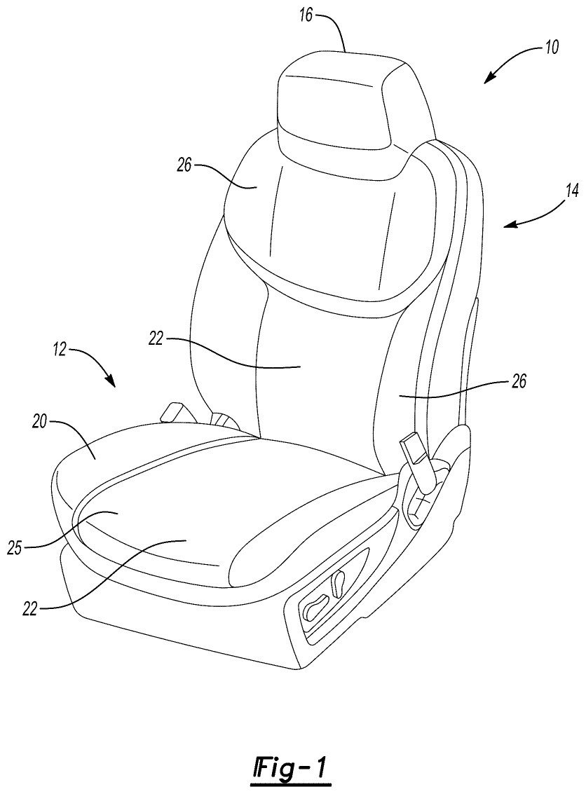

FIG. 1 illustrates a seat assembly 10 according to one example embodiment. The seat assembly 10 may be utilized as a vehicle seat assembly 10 for seating in a vehicle, such as an automobile, an aircraft, a watercraft, or any other seating environment. The seat assembly 10 includes a seat bottom 12, which may be adapted to be mounted for motor-driven adjustable translation in a fore and aft direction and in an up and down direction of a vehicle. The seat assembly 10 includes a seat back 14, which may be pivotally connected to the seat bottom 12 to extend generally upright relative to the seat bottom 12 for pivotal adjustment about an axis relative to the seat bottom 12.

The seat back 14 may include a head restraint 16 that may be configured to support the head of a seat occupant. The head restraint 16 may be disposed at the top of the seat back 14. The head restraint 16 may be unitary with the seat back 14 or may be a separate component that is adjustably positionable with respect to the top of the seat back 14. The seat bottom 12 may be configured to support a seat occupant. In a vehicular application, the seat bottom 12 may be mounted to a support surface, such as a vehicle floor. It should be understood that this is just one example of a seat configuration, and that other configurations could also be utilized.

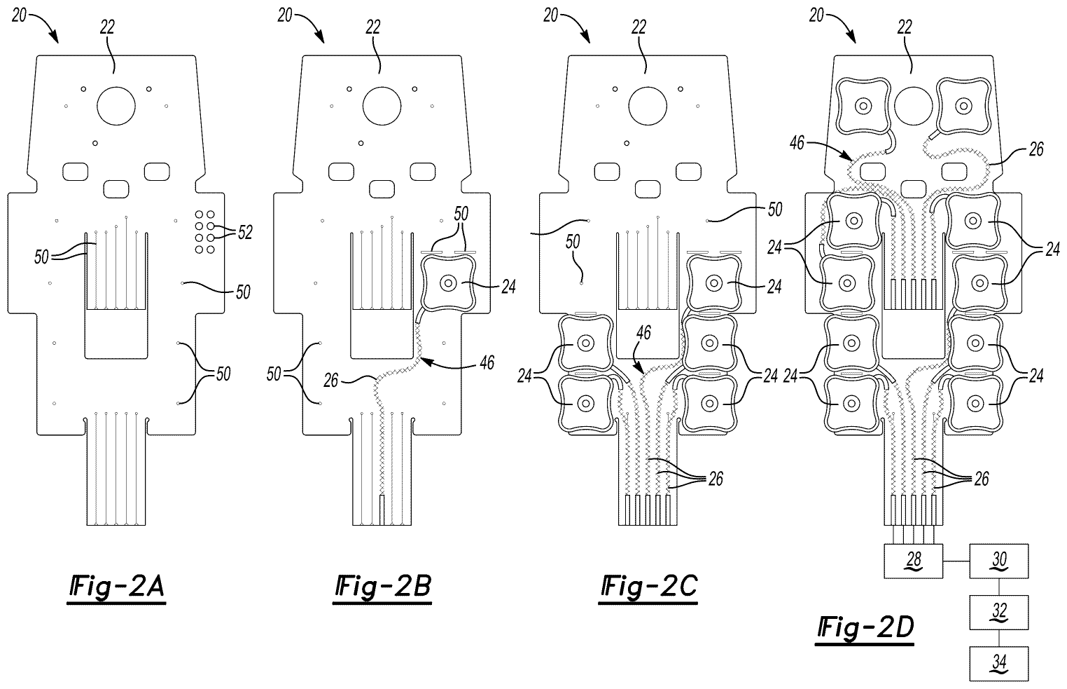

The seat back 14 and the seat bottom 12 may each have at least one seat component 20 (FIG. 2A) associated with a cushion 22 in the seat bottom 12 and/or the seat back 14. A trim cover 25 may be disposed over or upon the cushions 22 and may cover the seat component 20. The trim cover 25 provides at least a portion of a visible exterior surface of the seat assembly 10. The seat component 20 may be secured to the cushion 22 and/or trim cover 25 with one or more retention members 24. The trim cover 25 may include a plurality of trim panels that may be assembled in any suitable manner, such as by stitching. The trim panels may be made of any suitable material or materials, such as fabric, leather, vinyl, or combinations thereof.

FIGS. 2A-D illustrate a seat component 20 that comprises a carrier sheet or layer 22 that is made from one or more layers of material, and is associated with a plurality of bladders 24, e.g., expandable cells, and associated fluid lines 26 that define fluid flow paths to the plurality of bladders 24. In one example, the bladders 24 are used for bolster, lumbar and/or massage purposes.

In implementations, the fluid lines 26 comprise tubular members that connect a fluid supply to an inflatable member such as the bladders 24. As shown in FIGS. 2B-D, the bladders 24 comprise discrete inflatable/deflatable pouches or cells for that are used for massage and/or lumbar/bolster purposes.

In implementations, at least the fluid lines 26 are supported on the carrier layer 22.

In implementations, the fluid lines 26 and bladders 24 are supported on the carrier layer 22.

In implementations, the fluid lines 26 are associated with a pneumatic connector 28 (FIG. 2D) that is used to connect the tubing 26 to a valve bank 30, which is associated with an air source. An actuator assembly 32 controls inflation of the bladders 24 via the valve bank 30. The actuator assembly 32 may include a compressor or pneumatic pump connected to the valve bank 30 to provide a source of fluid to the bladders 24. A seat control module is associated with the seat assembly 10, and is identified generally as a controller 34. In one example, the controller 34 regulates compressed air into and out of the bladders 24 in the seat assembly 10. The controller 34 and actuator assembly 32 may be installed in the seat back 14, or installed under the seat, or anywhere suitable in the vehicle. Further, the controller 34 and actuator assembly 32 may be one unit or separate units from each other.

The controller 34 may include a processing unit and non-transitory memory for executing various control strategies. The processing unit can be a custom made or commercially available processor, a central processing unit (CPU), or generally any device for executing software instructions. The memory can include any one or combination of volatile memory elements and/or nonvolatile memory elements. The processing unit can be programmed to execute one or more programs stored in the memory. The programs may be stored in the memory as software code, for example. The programs stored in the memory may include one or more additional or separate programs, each of which includes an ordered list of executable instructions for implementing logical functions associated with controlling the valve bank. While shown as a single controller, the controller 34 may be comprised of one or more controllers. The controller 34 may also be in communication with, and responsive to instructions from, another controller.

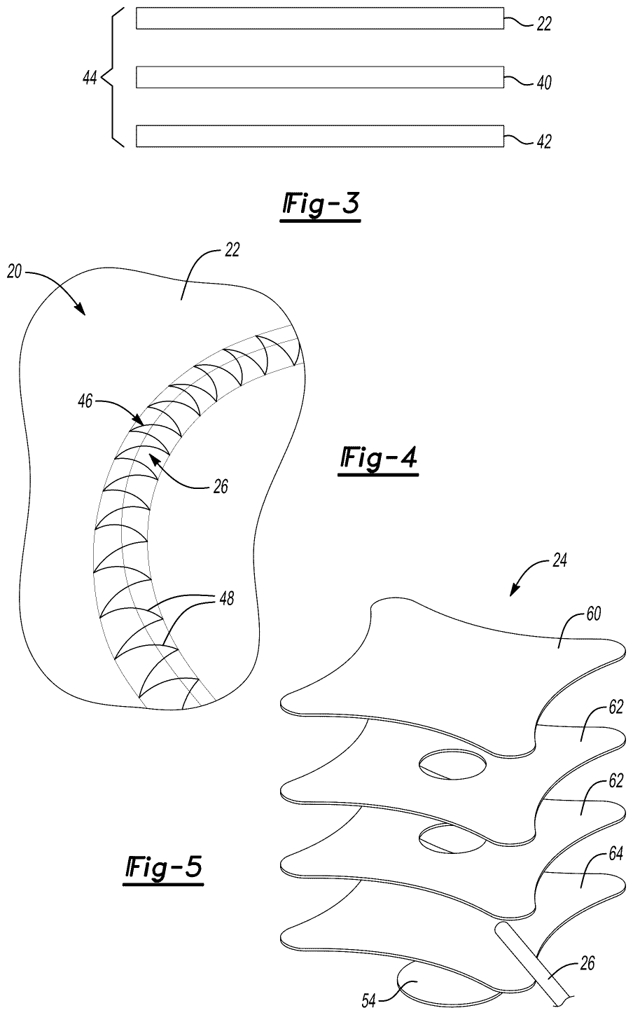

In implementations, the carrier sheet 22 may be combined with one or more additional comfort layers 40, 42 to form a comfort assembly 44 (see FIG. 3) that is placed on the seat and covered by the trim 25. In one example, the comfort layer 40 comprises a thermal comfort layer and includes heating/cooling components to adjust seat temperature. In one example, the comfort layer 42 comprises a ventilation comfort later used to adjust airflow through the seat.

In implementations, the carrier sheet 22 includes a stitched attachment 46 that attaches the fluid line 26 to a base material of the carrier layer 22. In one example, the stitched attachment 46 comprises an attachment interface where two or more materials are joined or fastened together using stitches, typically made with a needle and thread.

In implementations, type of machine may be used to form the stitched attachment 46.

In implementations, the base material of the carrier layer 22 comprises a nonwoven material or laminated foam material.

In one example, a nonwoven material comprises fabrics manufactured by bonding or interlocking fibers together without weaving or knitting, or fabrics made by directly bonding fibers together through a mechanical, chemical, or thermal processes.

In one example, a laminated foam material comprises a composite material comprised of multiple layers where a foam layer is bonded or laminated to one or more other materials. The foam layer provides cushioning and impact absorption properties, while the additional layers can serve purposes such as moisture barrier, heat insulation, or structural support. In implementations, lamination process may involve various methods such as adhesive bonding, heat sealing, or ultrasonic welding, depending on the materials and desired properties.

In implementations, the bladders 24 and tubing/fluid lines 26 are comprised of a plastic material such as a Thermoplastic Polyurethane (TPU) material, for example. This material is a versatile polymer that combines the properties of both plastic and rubber. TPU is a type of thermoplastic elastomer that exhibits properties such as elasticity, transparency, and resistance to oil, grease, and abrasion. It can be processed easily through injection molding, extrusion, and other thermoplastic processing techniques.

In implementations, the carrier layer 22 is die cut, for example, to provide a desired shape as shown in FIG. 2A.

In one example, the carrier layer 22 may have predefined fluid line position markings 50 for the plurality of fluid lines 26 and/or the plurality of bladders 24. The fluid line position markings 50 may comprise drawn lines/areas, notches, position holes, slots, etc., which are marked in predefined positions to define an alignment path or layout for the bladders 24 and fluid lines 26 in a desired arrangement.

In implementations, the carrier layer 22 may also have ventilation holes 52 if desired.

In implementations, as shown in FIG. 2B, the fluid line 26 is directly attached to the base material of the carrier layer 22 via the stitched attachment 46.

In one example, the stitched attachment 46 comprises a zigzag stitch 48 as shown in FIG. 4.

In implementations, each bladder 24 and associated fluid line 26 are attached to the carrier layer 22 one-one-by one until all bladders 24 and fluid lines 26 are attached (see FIGS. 2C-D). As such, there are plurality of bladders 24 and a plurality of fluid lines 26, and wherein each bladder 24 is associated with one fluid line 26.

In implementations, each bladder 24 is also directly stitched to the base material of the carrier layer 22.

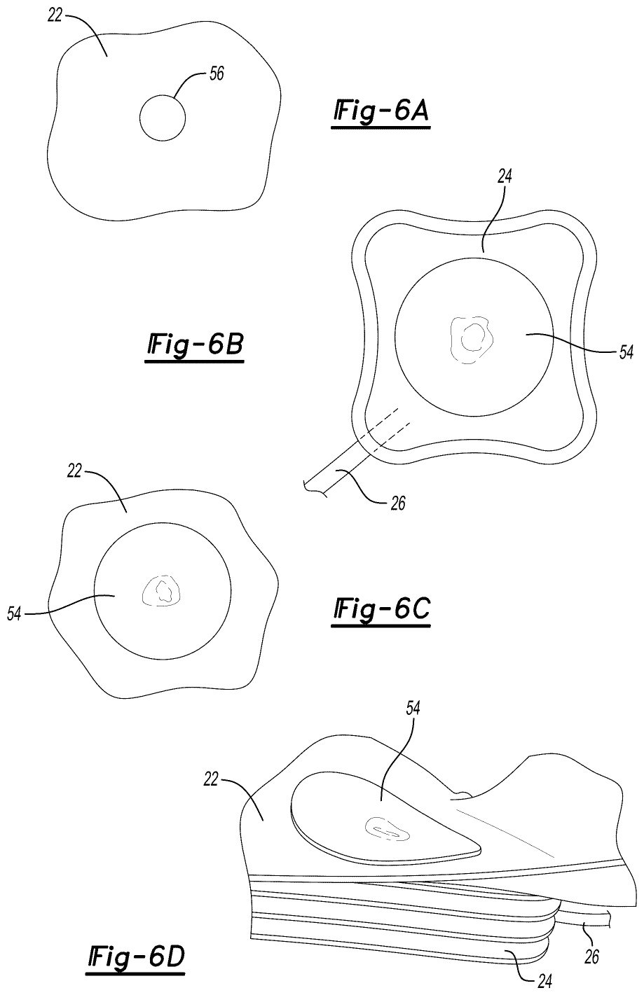

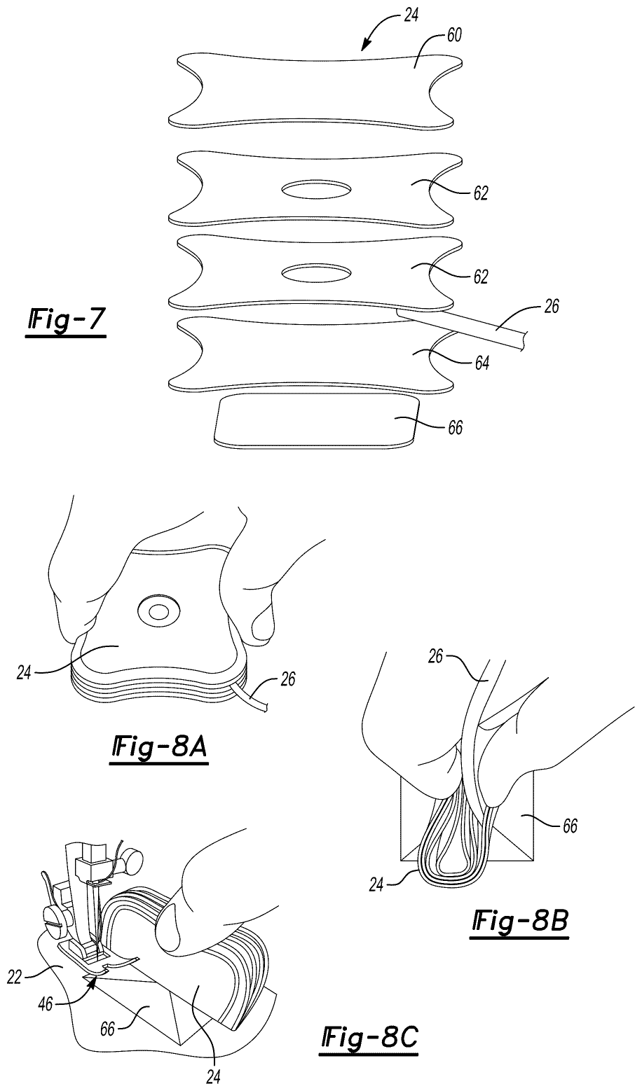

In implementations, each bladder 24 may include a protrusion or button 54 (FIG. 6B) and the carrier layer 22 includes at least one button opening 56 (FIG. 6A) that receives the button 54 (FIG. 6C) to hold the bladder 24 in place on the carrier layer 22. As shown in FIG. 6B, the button 54 extends outwardly of one side of the bladder 24. The button opening 56 comprises a slot or aperture that extends through a thickness of the carrier layer 22.

FIG. 5 shows an example of a multi-cell bladder 24 that comprises a top layer 60, two middle layers 62 to form a pair of connected cells, and a bottom layer 64 that includes the button 54. One end of an associated fluid line 26 is received within an inner chamber of the bladder 24.

In implementations, each bladder 24 may include a stitch flag 66 (FIG. 7) that lays flat on the carrier layer 22 and is stitched to the base material of the carrier layer 22 In one example, the stitch flag 66 comprises a flap of material secured at a center to the bladder 24 with edges lying flat on carrier layer 22 as shown in FIG. 8C.

FIG. 7 shows an example of a multi-cell bladder 24 that comprises a top layer 60, two middle layers 62 to form a pair of connected cells, and a bottom layer 64 that includes the stitch flag 66. One end of an associated fluid line 26 is received within an inner chamber of the bladder 24.

In implementations, the bladder 24 is grasped (FIG. 8A) and then pinched (FIG. 8B) such that the edges lay flat on the carrier layer 22 as shown in FIG. 8C. The flag 66 can then be attached via a stitched attachment 46.

In implementations, this allows for a less expensive material to be used for the carrier material, and a bladder production may be provided with a high potential of standardization and automation. There are also no noise issues and there is a low specific tooling cost.

In implementations, a sewing machine for the tube stitching should be able to operate in a “Zig-Zag” mode. Special presser feet may be needed for the tube stitching. In implementations, there may be a low capex and a high level of flexibility where it is easy to add on features/functions. Also, it is easy to combine with other comfort layers.

In implementations, a multi-head embroidery machine may be used. They may be a similar type of embroidery machine as used for seat heat comfort layers, but with removable frames. Specific templates may be designed, and an operator may remove a finished good and insert material into the removable frame/template while the machine is stitching. When the stitching done, the frame is exchanged and the next stitching can be started. In implementations, this may have less manual labor, better accuracy and repeatability, and may be less dependent on operator skill.

In implementations, the subject disclosure provides for an assembly that includes: at least one bladder; at least one fluid line; and a carrier layer comprising a base material supporting the at least one fluid line, wherein the at least one fluid line is attached to the base material via a stitched attachment.

The following features for the assembly may be included either alone or in any combination.

In one example, the base material of the carrier layer comprises a nonwoven material or laminated foam material.

In one example, the at least one fluid line is directly stitched to the base material.

In one example, at least one bladder is connectable to the at least one fluid line, wherein the at least one bladder is stitched to the base material.

In one example, the at least one bladder includes a button, and wherein the carrier layer includes at least one button opening, the button being received within the at least one button opening.

In one example, the at least one bladder includes a stitch flag, and wherein the stitch flag lays flat on the carrier layer and is stitched to the base material.

In one example, the carrier layer includes predefined fluid line position markings.

In one example, the predefined fluid line position markings comprise drawn identifiers, notches, or position holes defining an alignment path along the base material.

In one example, the at least one bladder comprises a plurality of bladders and the at least one fluid line comprises a plurality of fluid lines that are associated with the plurality of fluid lines.

In one example, each bladder of the plurality of bladders is associated with a dedicated fluid line of the plurality of fluid lines.

In one example, the carrier layer is stacked with one or more comfort layers as a trim assembly.

In one example, the carrier layer comprises an air barrier layer of a ventilation system.

In implementations, the subject disclosure provides for an assembly that includes a seat structure, one or more comfort layers associated with the seat structure, a carrier layer stacked with the one or more comfort layers, at least one fluid line connectable to at least one bladder, wherein the at least one fluid line are supported on the carrier layer, and a stitched attachment that attaches the at least one fluid line to a base material of the carrier layer.

The following features for the assembly may be included either alone or in any combination.

In one example, the base material of the carrier layer comprises a nonwoven material or laminated foam material.

In one example, the at least one bladder comprises a plurality of bladders and the at least one fluid line comprises a plurality of fluid lines, and wherein each bladder of the plurality of bladders is associated with one fluid line of the plurality of fluid lines.

In one example, each bladder is stitched to the base material.

In one example, each bladder includes a button, and wherein the carrier layer includes at least one button opening, the button being received within the at least one button opening.

In one example, the carrier layer includes predefined fluid line position markings for at least one of the plurality of fluid lines and the plurality of bladders.

In one example, the predefined fluid line position markings comprise drawn identifiers, notches, or position holes defining an alignment path along the base material.

In one example, each bladder includes a stitch flag, and wherein the stitch flag lays flat on the carrier layer and is stitched to the base material.

In one example, the one or more comfort layers comprise at least one of a thermal comfort layer and a ventilation comfort layer.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

One of ordinary skill in this art would understand that the above-described embodiments are exemplary and non-limiting. That is, modifications of this disclosure would come within the scope of the claims. Accordingly, the following claims should be studied to determine their true scope and content.

1. An assembly comprising:
at least one bladder;
at least one fluid line; and
a carrier layer comprising a base material supporting the at least one fluid line, wherein the at least one fluid line is attached to the base material via a stitched attachment.

2. The assembly of claim 1, wherein the base material of the carrier layer comprises a nonwoven material or laminated foam material.

3. The assembly of claim 1, wherein the at least one fluid line is directly stitched to the base material.

4. The assembly of claim 1, including at least one bladder connectable to the at least one fluid line, wherein the at least one bladder is stitched to the base material.

5. The assembly of claim 4, wherein the at least one bladder includes a button, and wherein the carrier layer includes at least one button opening, the button being received within the at least one button opening.

6. The assembly of claim 4, wherein the at least one bladder includes a stitch flag, and wherein the stitch flag lays flat on the carrier layer and is stitched to the base material.

7. The assembly of claim 1, wherein the carrier layer includes predefined fluid line position markings.

8. The assembly of claim 7, wherein the predefined fluid line position markings comprise drawn identifiers, notches, or position holes defining an alignment path along the base material.

9. The assembly of claim 1, wherein the at least one bladder comprises a plurality of bladders and the at least one fluid line comprises a plurality of fluid lines that are associated with the plurality of fluid lines.

10. The assembly of claim 9, wherein each bladder of the plurality of bladders is associated with a dedicated fluid line of the plurality of fluid lines.

11. The assembly of claim 1, wherein the carrier layer is stacked with one or more comfort layers as a trim assembly.

12. The assembly of claim 11, wherein the carrier layer comprises an air barrier layer of a ventilation system.

13. An assembly comprising:
a seat structure;
one or more comfort layers associated with the seat structure;
a carrier layer stacked with the one or more comfort layers;
at least one fluid line connectable to at least one bladder, wherein the at least one fluid line are supported on the carrier layer; and
a stitched attachment that attaches the at least one fluid line to a base material of the carrier layer.

14. The assembly of claim 13, wherein the base material of the carrier layer comprises a nonwoven material or laminated foam material.

15. The assembly of claim 14, wherein the at least one bladder comprises a plurality of bladders and the at least one fluid line comprises a plurality of fluid lines, and wherein each bladder of the plurality of bladders is associated with one fluid line of the plurality of fluid lines.

16. The assembly of claim 15, wherein each bladder is stitched to the base material.

17. The assembly of claim 16, wherein each bladder includes:
a button, and wherein the carrier layer includes at least one button opening, the button being received within the at least one button opening.

18. The assembly of claim 16, wherein the carrier layer includes predefined fluid line position markings for at least one of the plurality of fluid lines and the plurality of bladders, and wherein the predefined fluid line position markings comprise drawn identifiers, notches, or position holes defining an alignment path along the base material.

19. The assembly of claim 16, wherein each bladder includes:
a stitch flag, and wherein the stitch flag lays flat on the carrier layer and is stitched to the base material.

20. The assembly of claim 13, wherein the one or more comfort layers comprise at least one of a thermal comfort layer and a ventilation comfort layer.
